(19) United States
(12) Patent Application Publication
(10) Pub. No.: US 2003/0151244 A1
(43) Pub. Date: Aug. 14, 2003

(54) B C

(76) Inventors: Robert J. Hay, Benicia, CA (US); Casey Amanda Batchelder, Rodeo, CA (US)

Correspondence Address: ROBERT J. HAY, 115 WOODSTOCK CT., BENICIA, CA, 94510, US

(21) Appl. No.: 10/072,206

(22) Filed: Feb. 11, 2002

(51) Int. Cl. B42D 3/00

(52) U.S. Cl. 281/31

(57) ABSTRACT

The ACCORDION CENTERFOLD SECTION of the “B C” will allow the holder to cover and protect different books, with different book binding widths. This ACCORDION CENTERFOLD SECTION design is a completely new concept. Not only does the “B C” provide for the ACCORDION CENTERFOLD SECTION design, it also has the capability of inserting and protecting papers, notes, and/or worksheets in its FOUR (4) POCKETS. Since these POCKETS are inside the book binding, they receive additional protection from damage.

### CROSS-REFERENCE TO RELATED APPLICATIONS

Non Applicable

### STATEMENT REGARDING FEDERALLY SPONSORED RESEARCH OR DEVELOPMENT

Non Applicable

### REFERENCE TO MICROFICHE APPENDIX

Non Applicable

### BACKGROUND OF THE INVENTION

### Often students stuff papers in between the pages of a book. This can damage the book, plus the possibility of the papers falling out and being lost.

Ms. Casey Batchelder was a student of mine. Her history book was covered in such a matter that papers could be inserted inside the book binding held in place by use of the covering.

The following year, we discussed the possibilities of inventing a new type of “BOOK COVER”. After many hours of experimentation with different models, we came to the conclusion that this “BOOK COVER”, hence the title “B C”, fulfilled all of our needs.

Book covers on the market today, and in the past, don't handle the ability to cover a book plus secure and protect papers, notes, and/or worksheets with an ACCORDION CENTERFOLD SECTION Which adjusts for the different widths of book bindings.

### BRIEF SUMMARY OF THE INVENTION

The “B C” which helps protect the book binding from wear, while affording the owner ADDITIONAL SLOTS to insert papers, notes, and/or worksheets pertaining to the books subject manner. The ACCORDION CENTERFOLD SECTION allows for different widths in book bindings.

### BRIEF DESCRIPTION OF THE SEVERAL VIEWS OF THE DRAWING(S)

FIG. 1, on PACE 3 OF 12, is a closed frontal view. You are viewing it closed, placed down on its backside. As you look from the bottom of the paper to the top, you are viewing the “B C” from the bottom to the top.

FIG. 2, on PAGE 4 OF 12, is an open frontal view. You are viewing it opened, placed down on its backside. As you look from the bottom of the paper to the top, you are viewing the “B C” from the bottom to the top.

FIG. 3, on PAGE 5 OF 12, is an open frontal view. You are viewing it opened, placed down on its backside. As you look from the bottom of the paper to the top, you are viewing the “B C” from the top to the bottom.

FIG. 4, on PAGE 6 OF 12, is an open backside view. You are viewing it opened, placed down on its inside. As you look from the bottom of the paper to the top, you are viewing the folder from the bottom to the top.

FIG. 5, on PACE 7 OF 12, is an open backside view. You are viewing it opened, front side down. As you look from the bottom of the paper to the top, you are viewing the “B C” from the top to the bottom.

FIG. 6, on PACE 8 OF 12, is the “B C”open with a book inserted into the pockets. You can notice the ACCORDION CENTERFOLD SECTION has been expanded to cover the larger widths of book bindings. Papers, notes, and/or worksheets are also inserted into the pockets. As you look from the bottom of the paper to the top, you are viewing the “B C” covering a book with papers inserted into its pockets from the bottom to the top.

### DETAILED DESCRIPTION OF THE INVENTION

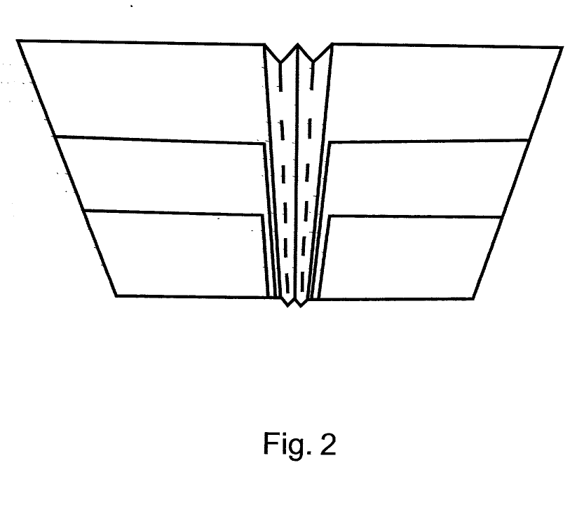

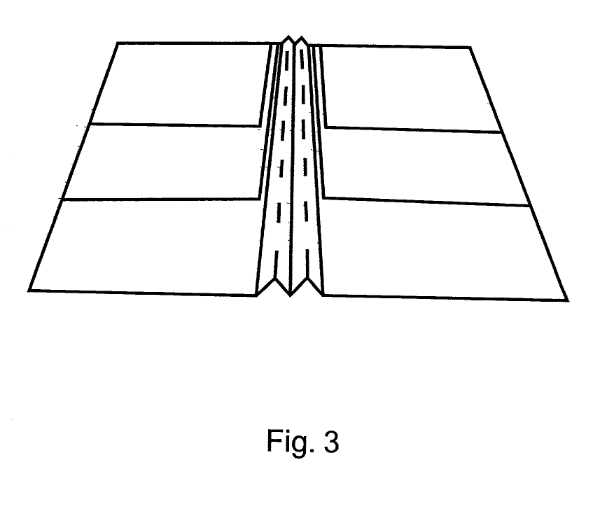

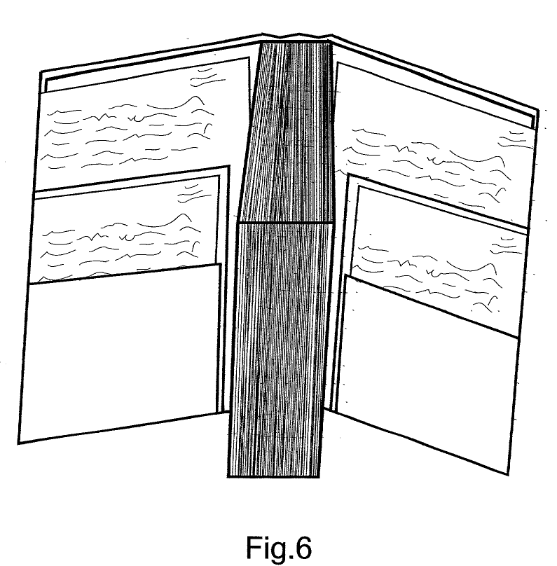

The “B C” allows for the book binding to be inserted into the back pockets for covering and protection from wear, plus allow papers, notes, and/or worksheets to be stored inside the pockets, inside the book binding. (FIG. 2, on PAGE 4 OF 12, FIG. 3, on PAGE 5 OF 12, and FIG. 6, on PAGE 8 OF 12, all demonstrate this point.)

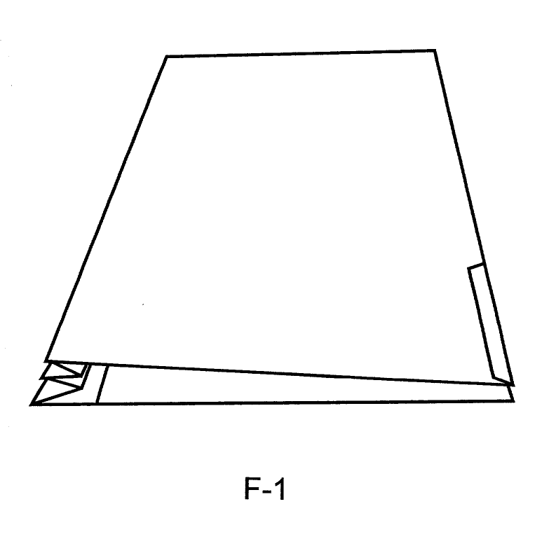

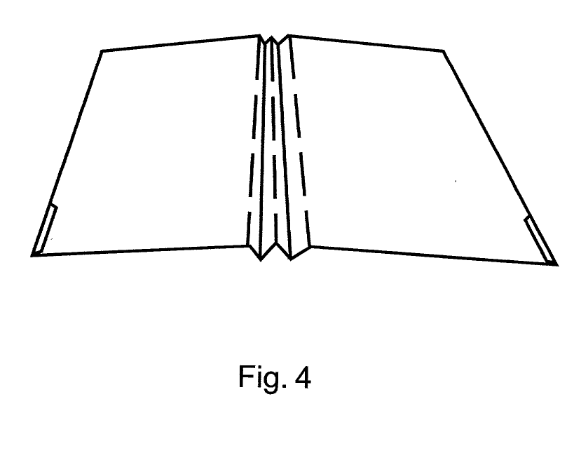

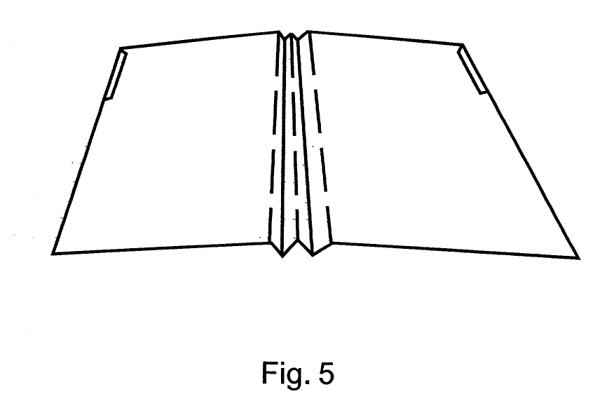

The ACCORDION CENTERFOLD SECTION adjusts to different widths of book bindings. (FIG. 1, on PAGE 3 OF 12, FIG. 2, on PAGE 4 OF 12, FIG. 3,on PAGE 5 OF 12, FIG. 4, on PAGE 6 OF 12, FIG. 5, on PAGE 7 OF 12, and FIG. 6, on PAGE 8 OF 12, all exhibit this point.)

The “B C” could be made of any material used for covering books, i.e. railroad board, pliable plastics, etc.

The drawings we previously referred to are on PAGE 3 OF 12, PAGE 4 OF 12, PAGE 5 OF 12, PAGE 6 OF 12, PAGE 7 OF 12, and PAGE 8 OF 12.

### OATH OF DECLARATION

Forms PTO/SB/01, PTO/SB/02A, PTO/SB/02B, and PTO/SB/02C all succeed PAGE 12.

### SEQUENCE LISTING

Non Applicable

1. We claim as our invention, the ACCORDION CENTERFOLD SECTION. This invention gives the “B C” the ability to expand, thus it has the ability to cover and protect book bindings with different widths.

2. We claim as our invention, the “B C's” four (4) horizontal and inside opening pockets. These POCKETS allow for paper, notes, and/or worksheets to be inserted and secured inside the book bindings.
